(19) United States
(12) Patent Application Publication
(10) Pub. No.: US 2012/0083541 A1
(43) Pub. Date: Apr. 5, 2012

(54) AROMATIC POLYETHER SULFONE BLOCK COPOLYMERS

(75) Inventors: Alexander Khvorost, Ludwigshafen (DE); Martin Weber, Maikammer (DE); Christian Schmidt, Ludwigshafen (DE); Jörg Belack, Mainz (DE); Cecile Gibon, Mannheim (DE); Bernd-Steffen Von Bernstorff, Wachenheim (DE)

(73) Assignee: BASF SE, Ludwigshafen (DE)

(21) Appl. No.: 13/377,979

(22) PCT Filed: Jun. 15, 2010
(86) PCT No.: PCT/EP2010/058390

§ 371 Date: Dec. 13, 2011

(30) Foreign Application Priority Data
Jun. 16, 2009 (EP) 09162858.6

(51) Int. Cl. C08G 75/23; C08J 5/22

(52) U.S. Cl. 521/27; 521/30

(57) ABSTRACT

An aromatic polyether sulfone block copolymer comprises hydrophilic segments which have sulfonic acid groups and hydrophobic segments which have no sulfonic acid groups, wherein the proportion by weight of hydrophilic segments is from 0.02 to 0.35.

The invention relates to aromatic polyether sulfone block copolymers, processes for preparing them and their use in fuel cells or as membranes for water treatment.

The use of polyelectrolytes based on aromatic polyether sulfone block copolymers for solid polymer fuel cells is known per se. Appropriate copolymers are described in EP-A-1 394 879. These are, in particular, polyether sulfone (PES)-polyphenyl sulfone (PPSU) block copolymers which have been sulfonated by means of concentrated sulfuric acid at room temperature. The ratio of hydrophilic segments to hydrophobic segments is in the range from 0.6 to 2.0 and the proportion by weight of the hydrophilic segments is above 0.375.

US 2004/0138387 relates to block copolymers and their use as polymer electrolyte in fuel cells. The sulfonation is carried out using concentrated sulfuric acid at temperatures of from 40 to 60° C. The polymers are, in particular, polyether ether sulfones.

EP-A-1 113 517 relates to polymer electrolytes and processes for producing them. Here, for example, a block copolymer of bis(hydroxyphenyl) sulfone, dihydroxybiphenyl and bis(chlorophenyl) sulfone is prepared and subsequently sulfonated using concentrated sulfuric acid.

Similar polymeric materials are also used for producing membranes for the desalination of water. Angew. Chem. Int. Ed. 2008, 47, pages 1 to 7, describes chlorine-tolerant polymers for the desalination of water. These are polyarylene ether sulfone copolymers which are prepared from disulfonated monomers and unsulfonated monomers.

It is an object of the present invention to provide improved aromatic polyether sulfone block copolymers which can be used as polyelectrolyte in the production of fuel cells or as membrane for water treatment. The polymers should display improved use properties or a suitable property profile, in particular in respect of the proton conductivity, methanol permeation and swelling. For water treatment, they should also have good chemical resistance and resistance to fouling.

The object is achieved according to the invention by an aromatic polyether sulfone block copolymer comprising hydrophilic segments which have sulfonic acid groups and hydrophobic segments which have no sulfonic acid groups, wherein the proportion by weight of hydrophilic segments is from 0.02 to 0.35, based on the total block copolymer (corresponding to from 2 to 35% by weight).

The object is additionally achieved by a process for preparing such aromatic polyether sulfone block copolymers, wherein an aromatic polyether sulfone block copolymer is sulfonated by means of concentrated sulfuric acid at a temperature in the range from 20 to 70° C.

The object is additionally achieved by the use of the above aromatic polyether sulfone block copolymers as polyelectrolyte for producing fuel cells or for producing membranes for water treatment.

The invention additionally provides a fuel cell comprising an aromatic polyether sulfone block copolymer as described above as polyelectrolyte.

The invention further provides a membrane for water treatment comprising an aromatic polyether sulfone block copolymer as described above.

The aromatic polyether sulfone block copolymers of the invention have an advantageous spectrum of mechanical and chemical use properties which make them suitable both as polyelectrolyte and for producing membranes.

Preferred block copolymers and their preparation are described in more detail below.

In the block copolymers of the present invention, the hydrophilic segments differ from the hydrophobic segments in that the hydrophilic segments have sulfonic acid groups while the hydrophobic segments do not. The proportion by weight of hydrophilic segments is in the range from 0.02 to 0.35, preferably from 0.05 to 0.30.

In an embodiment of the invention, the proportion by weight is from 0.15 to 0.35. Such block copolymers are suitable, in particular, as polyelectrolytes for producing fuel cells.

In another embodiment of the invention, the proportion by weight is from 0.02 to 0.25. The preparation by weight is always based on the total block copolymer. Such block copolymers are suitable, in particular, for producing membranes for water treatment.

For the purposes of the present invention, hydrophilic segments are segments which have sulfonic acid groups. Correspondingly, hydrophobic segments are segments which do not have any sulfonic acid groups.

The hydrophilic segments can be composed of any aromatic hydrophilic segments as long as they have sulfonic acid groups and are suitable for preparing block copolymers with the hydrophobic segments.

The hydrophilic segments preferably comprise sulfonated polyphenylene sulfone (PPSU) building blocks. These preferably have the general formula (2)

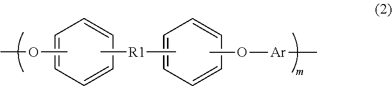

where R1 is C(═O) or S(═O)₂, Ar is a divalent aromatic radical and m is an integer from 3 to 1500, preferably from 5 to 500. The radical Ar can also have a meaning as given in EP-A-1 394 879 for the structures of the general formula (2).

R1 is preferably S(═O)₂.

The aromatic radical Ar is preferably a polycyclic aromatic radical, preferably a biphenyl radical of the general formula (3)

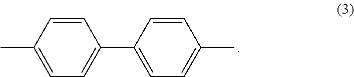

It is thus particularly preferably a polyphenyl sulfone radical.

In the biphenyl radical of the general formula (3), the phenyl groups can also be connected via a —C(CH₃)₂— group.

The radical of the general formula (2) is converted by subsequent sulfonation into the hydrophilic segments. Particular preference is given to each of the phenylene groups in the formula (3) bearing a sulfonic acid group after sulfonation. The sulfonic acid group is preferably present in the ortho position relative to the oxygen bound to the group.

The hydrophobic segments are preferably polyether sulfone segments. The hydrophobic segments preferably have the general formula (1)

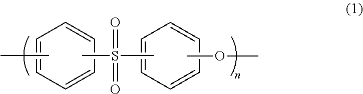

where n is an integer from 3 to 1500.

The polyether sulfone particularly preferably has the formula (4)

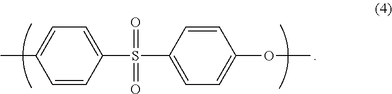

According to the invention, a block copolymer, in particular a block copolymer composed of polyether sulfone units and polyphenyl sulfone units, is firstly prepared and the block copolymer obtained is subsequently selectively sulfonated by means of concentrated aqueous sulfuric acid (about 98% strength). Preference is given to only the groups of the above formula (3) being sulfonated here.

In the preparation of the aromatic polyether sulfone block copolymers of the present invention, the aromatic polyether sulfone block copolymers are preferably sulfonated by means of concentrated sulfuric acid at a temperature in the range from 20 to 70° C., preferably from 25 to 50° C.

The polyether sulfone blocks and polyphenyl sulfone blocks are preferably present in the block copolymer of the invention in such a way that the polymer blocks display a phase separation in the order of from 10 to 100 nm. Compared to random copolymers, the sulfonated block copolymers PES/sPPSU have the advantage of a strong separation in the abovementioned range from 10 to 100 nm.

As a result of the phase separation in the nanometer range, the block copolymers simultaneously acquire properties such as mechanical stability, low swelling of sheets in water/methanol and high water permeability or high ion conductivity. This combination of properties which sometimes run counter to one another cannot be achieved by means of random copolymers. For example, random PES-PPSU copolymers having PPSU contents of more than 20% can be isolated only with great difficulty, if at all, after sulfonation because of the strong swelling or the solubility in water. Block copolymers having PPSU contents of up to 35% by weight can always still be isolated.

M is preferably a number in the range from 5 to 500.

Particular preference is given to the hydrophilic segments corresponding to the formula (7) reported in EP-A-1 394 879 and the hydrophobic segments corresponding to the formula (8) reported there.

The sulfonic acid groups of the block copolymer of the invention preferably have an ion exchange capacity of from 0.07 to 1.43 mmol/g, particularly preferably from 0.178 to 1.07 mmol/g.

The preparation of the aromatic polyether sulfone block copolymers of the invention is effected by firstly synthesizing an unsulfonated block copolymer which is subsequently sulfonated.

An aromatic polyether sulfone can be used as prepolymer having a hydrophobic segment. It is synthesized, for example, by reaction of a dialkali metal salt of a dihydric phenol with an aromatic dihalide, as taught in R. N. Johnson et al., J. Polym. Sci., A-1, Vol. 5, 2375 (1967) and JP-B-46-21458.

The aromatic dihalide comprises bis(4-chlorophenyl) sulfone, bis(4-fluorophenyl) sulfone, bis(4-bromophenyl) sulfone, bis(4-iodophenyl) sulfone, bis(2-chlorophenyl) sulfone, bis(2-fluorophenyl) sulfone, bis(2-methyl-4-chlorophenyl) sulfone, bis(2-methyl-4-fluorophenyl) sulfone, bis(3,5-dimethyl-4-chlorophenyl) sulfone and bis(3,5-dimethyl-4-fluorophenyl) sulfone. These can be used either individually or as a combination of two or more thereof. Among these compounds, bis(4-chlorophenyl) sulfone and bis(4-fluorophenyl) sulfone are preferred.

The dihydric alcohol comprises bis(4-hydroxyphenyl) sulfone and bis(4-hydroxyphenyl) ketone, with bis(4-hydroxyphenyl) sulfone being preferred.

The dialkali metal salt of a dihydric phenol can be obtained by reaction of the dihydric phenol with the alkali metal compound, for example potassium carbonate, potassium hydroxide, sodium carbonate or sodium hydroxide.

A combination of the sodium or potassium salt of bis(4-hydroxyphenyl) sulfone and bis(4-chlorophenyl) sulfone or bis(4-fluorophenyl) sulfone is a preferred combination of the dialkali metal salt of a dihydric phenol and the aromatic dihalide.

The reaction of the dialkali metal salt of a dihydric phenol with the aromatic dihalide is carried out in a polar solvent, for example dimethyl sulfoxide, sulfolane, N-methyl-2-pyrrolidone, 1,3-dimethyl-2-imidazolidinone, N,N-dimethylformamide, N,N-dimethylacetamide and diphenyl sulfone. The reaction temperature is preferably from 140° C. to 320° C. The reaction time is preferably from 0.5 hour to 100 hours.

The use of either the dihydric phenol or the aromatic dihalide in excess leads to formation of end groups which can be used for monitoring the molecular weight of the prepolymer and for the synthesis of the block copolymer. Otherwise, the dihydric phenol or the aromatic dihalide are used in equimolar amounts, and either a monohydric phenol, for example phenol, cresol, 4-phenylphenol or 3-phenylphenol, or an aromatic halide, for example 4-chlorophenyl phenyl sulfone, 1-chloro-4-nitrobenzene, 1-chloro-2-nitrobenzene, 1-chloro-3-nitrobenzene, 4-fluorobenzophenone, 1-fluoro-4-nitrobenzene, 1-fluoro-2-nitrobenzene or 1-fluoro-3-nitrobenzene, is added.

The degree of polymerization of the prepolymer is in the range from 3 to 1500, preferably from 5 to 500. At a degree of polymerization of less than 3, the block copolymer synthesized therefrom barely displays the desired properties: At a degree of polymerization of more than 1500, it is difficult to synthesize the block copolymer.

Since an aromatic ring to which an electron withdrawing group is bound is difficult to sulfonate, preference is given to the prepolymer composed of a hydrophobic segment having an electron withdrawing group such as C(═O) or S(═O)₂ which is bound to the aromatic ring of the same. A preferred prepolymer composed of a hydrophobic segment has a structure shown by the chemical formula (I):

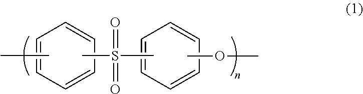

where n is an integer from 3 to 1500.

The prepolymer composed of an unsulfonated, hydrophilic segment, which is used in the process (1), is preferably synthesized from an aromatic dihalide and a dihydric phenol without an electron withdrawing group on an aromatic ring. The dihydric phenol without an electron withdrawing group on its aromatic ring comprises hydroquinone, resorcinol, 1,5-dihydroxynaphthalene, 1,6-dihydroxynaphthalene, 1,7-dihydroxynaphthalene, 2,7-dihydroxynaphthalene, 4,4′-biphenol, 2,2′-biphenol, bis(4-hydroxyphenyl) ether, bis(2-hydroxyphenyl) ether, 2,2-bis(4-hydroxyphenyl)-propane, 2,2-bis(3-methyl-4-hydroxyphenyl)propane, 2,2-bis(3,5-dimethyl-4-hydroxyphenyl)propane, bis(4-hydroxyphenyl)methane, 2,2-bis(3,5-dimethyl-4-hydroxyphenyl)-hexafluoropropane and 9,9-bis(4-hydroxyphenyl)fluorene. Among these, hydroquinone, resorcinol, 1,5-dihydroxynaphthalene, 1,6-dihydroxynaphthalene, 1,7-dihydroxynaphthalene, 2,7-dihydroxynaphthalene, 4,4′-biphenol, 2,2′-biphenol, bis(4-hydroxyphenyl) ether, bis(2-hydroxyphenyl) ether and 9,9-bis(4-hydroxyphenyl)fluorene are preferred.

The aromatic dihalide comprises those having a sulfone group, which are useful for synthesizing the prepolymer of a hydrophobic segment, and also those having a ketone group, for example 4,4′-difluorobenzophenone and 2,4′-difluorobenzophenone. The most desirable prepolymer of an unsulfonated, hydrophilic segment is one having the structure of the chemical formula (2):

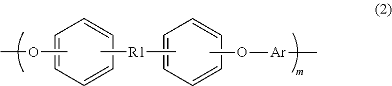

where R1 is C(═O) or S(═O)₂; Ar is a divalent, aromatic radical; and m is an integer from 3 to 1500.

Polyether sulfones can be obtained, for example, under the trade name Sumikaexcel® from Sumitomo Chemical Co., Ltd. Polyaryl ether sulfones can be obtained, for example, under the trade name Radel® from Solvay.

Modification of the molecular weight and the end groups of commercially available polymers can be effected by ether exchange with the abovementioned alkali metal salts of dihydric phenols or of monohydric phenol under the same conditions as for the synthesis of the aromatic polyether sulfones, which are described in R. N. Johnson et al., J. Polym. Sci., A-1, Vol. 5, 2375 (1967) or JP-B-46-21458.

The unsulfonated block copolymer is synthesized by reaction of the above-described prepolymer of a hydrophobic segment with the prepolymer of an unsulfonated, hydrophilic segment. Preference is given to the prepolymer of a hydrophobic segment having a halogen end group or an end group of an alkali metal salt of a phenol. It is preferred that the prepolymer of an unsulfonated, hydrophilic segment has a corresponding halogen end group or a corresponding end group of an alkali metal salt of a phenol. The reaction is carried out in the abovementioned solvent at a reaction temperature of from 140° C. to 320° C. for a reaction time of from 0.5 hour to 100 hours. This reaction is described, for example, in Z. Wu et al., Angew. Makromol. Chem., Vol. 173, 163 (1989) and Z. Wang et al., Polym. Int., Vol. 50, 249 (2001).

The unsulfonated block copolymer can also be synthesized by reaction between the two segment prepolymers which each have an end group of an alkali metal salt of a phenol by using a coupling agent in the same way. The abovementioned aromatic dihalides can be used as coupling agent. Aromatic difluorides, for example bis(2-fluorophenyl) sulfone and bis(4-fluorophenyl) sulfone, are preferred as coupling agents because of their high reactivity. Sulfonation of products from direct coupling is possible.

The sulfonation is, according to the invention, carried out at a temperature of from 20 to 70° C. by means of sulfuric acid. The sulfuric acid preferably has a concentration of from 90 to 98% by weight, in particular 98% by weight. In this temperature range, only the hydrophilic segment is successfully sulfonated since the hydrophobic segment which has an electron withdrawing group bound to the aromatic ring cannot be sulfonated.

In the case of full sulfonation, the degree of sulfonation is thus determined by the polyphenyl sulfone (PPSU) segments which are incorporated in the polycondensation. During sulfonation, all PPSU blocks are fully sulfonated. The degree of sulfonation can be very readily set via the molar mass and the segment length of the PES/PPSU block copolymers.

Compared to random copolymers, the sulfonated block copolymers of the invention have the advantage of strong phase separation. The polymer blocks preferably display a phase separation in the order of from 10 to 100 nm.

Polymers according to the invention preferably have, based on the unsulfonated polymer, a weight average molecular weight (Mw) in the range from 1 to 200 kg/mol, particularly preferably from 5 to 100 kg/mol, in particular from 5 to 70 kg/mol, determined by gel permeation chromatography/size exclusion chromatography (GPC/SEC). The method is adequately known to those skilled in the art and corresponds to the state of research.

The measurement conditions were selected as follows: the polymers were dissolved at a concentration of 2 g/l in DMAc (dimethylacetamide) with addition of 0.5% of salt. Prefiltration of the solution is carried out through a standard syringe filter having a pore size of 0.2 μm. The amount injected is 200 μl at a column temperature of 80° C. Size exclusion chromatography was carried out using a combination of several columns (calculated theoretical plates for the selected column combination and flow rate: 17 200). The signals were detected by means of a differential refractometer (determination of the index of refraction). Calibration was carried out using narrowly distributed PMMA standards from PSS having molecular weights of from M=800 to M=1 820 000 g/mol. All values determined are within the boundaries of the standard.

The invention also provides for the use of the aromatic polyether sulfone block copolymers as described above as polyelectrolyte for producing fuel cells or for producing membranes for water treatment. The use of polyelectrolyte membranes in fuel cells is generally known. Reference may here be made to, for example, EP-A-1 394 879, EP-A-1 113 517, US 2004/0138387, EP-A-1 669 391 and EP-A-1 855 339. Polyelectrolyte membranes can be obtained, for example, by film formation processes using the block copolymers of the invention.

The process for film formation in order to achieve a polyelectrolyte membrane for a cell having a solid polymeric fuel of the present invention, starting from a block copolymer of an aromatic polyether sulfone which has been prepared in this way, is not restricted in any particular way. For example, the block copolymer of an aromatic polyether sulfone is dissolved in a polar solvent, for example dimethyl sulfoxide, sulfolane, N-methyl-2-pyrrolidone, 1,3-dimethyl-2-imidazolidinone, N, N-dimethylformamide, N,N-dimethylacetamide or diphenyl sulfone, the solution is poured onto a support and the (polar) solvent is removed, e.g. by evaporation. The film thickness is from 5 to 200 μm, preferably from 10 to 150 μm. A film which is thinner than 5 μm is typically difficult to handle. A film which is thicker than 200 μm is unfavorable since a fuel cell comprising such a membrane displays reduced effectiveness in power generation.

If desired, part of the sulfonic acid groups in the polyelectrolyte membrane of the present invention can be present in the form of a metal salt, as long as the properties of the present invention are not impaired. Furthermore, the membrane can be reinforced by means of fibers, a porous film and the like. If necessary, the polyelectrolyte membrane can comprise inorganic acids, which can be mixed with one another, for example phosphoric acid, hypophosphorous acid and sulfuric acid or salts thereof, perfluoroalkylsulfonic acids having from 1 to 14 carbon atoms or salts thereof, perfluoroalkylcarboxylic acids having from 1 to 14 carbon atoms or salts thereof, inorganic substances, for example platinum, silica gel, silicon dioxide and zeolites and other polymers.

The production of the fuel cell is not subject to any restrictions.

The production of a membrane-electrode assembly (MEA) can occur by pressing with a gas diffusion electrode (GDE) or by direct coating with a catalyst solution, e.g. by screen printing. This gives a catalyst coated membrane (CCM).

The aromatic polyether sulfone block copolymers of the invention can also be used for producing membranes for water treatment. The production of such membranes is described, for example, in Angew. Chem. Int. Ed. 2008, 47, pages 1 to 7. The membrane is, in particular, produced by casting of a solution of the polymer onto a flat substrate such as a glass plate and subsequent removal of the solvent. The removal of the solvent can be carried out, for example, with heating or by application of a reduced pressure.

Membranes for water treatment are generally semipermeable membranes which allow separation of dissolved and suspended particles from water, with the separation process itself being able to be driven by pressure or electrically. Typical but not limiting membrane use examples for the polymers of the invention are pressure-driven membrane technologies such as microfiltration (MF; separation limit from about 0.08 to 2 μm; very small, suspended particles, colloids, bacteria), ultrafiltration (UF; separation limit from about 0.005 to 0.2 μm; organic particles>1000 MW, viruses, bacteria, colloids), nanofiltration (NF, separation limit from 0.001 to 0.01 μm, organic particles>300 MW, THM precursors, viruses, bacteria, colloids, dissolved substances) or reverse osmosis (RO, separation limit from 0.0001 to 0.001 μm, ions, organic substances>100 MW). The production of all membranes can be carried out from the polymers of the invention.

The production routes for all membranes are known in the literature and are described, for example, by M. C. Porter et al. in Handbook of Industrial Membrane Technology (William Andrew Publishing/Noyes, 1990). The most frequent, nonlimiting configuration example for the polymers of the invention in systems are filtration modules composed of hollow fibers or wound membrane modules. These are likewise known to those skilled in the art and are described in the literature (see above).

Possible but nonlimiting ways of producing membranes for various applications in the field of water treatment from the polymers of the invention are presented in FIG. 1-1 of Handbook of Industrial Technology (edited by Mark C. Porter, Pleasanton, Calif. Reprint Edition Noyes Publications, Westwood, N.J., USA).

The invention also provides corresponding fuel cells comprising an aromatic polyether sulfone block copolymer according to the invention as polyelectrolyte and a membrane for water treatment comprising an aromatic polyether sulfone block copolymer according to the invention as membrane material.

1-12. (canceled)

13. An aromatic polyether sulfone block copolymer comprising hydrophilic segments which have sulfonic acid groups and hydrophobic segments which have no sulfonic acid groups, wherein the proportion by weight of hydrophilic segments is from 0.05 to 0.30, wherein the hydrophobic segments comprise polyether sulfone building blocks and the hydrophilic segments comprise sulfonated polyphenylene sulfone building blocks.

14. The block copolymer according to claim 13, wherein the polyether sulfone building blocks comprise repeating units of the general formula (1) 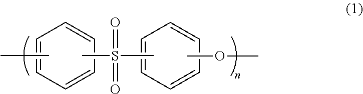
where n is a number in the range from 3 to 1500.

15. The block copolymer according to claim 13, wherein the sulfonated polyphenylene sulfone building blocks are obtained by sulfonation of structural units of the general formula (2) 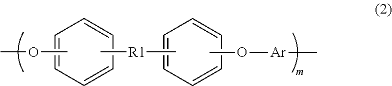
where R1 is C(═O) or S(═O)₂;
Ar is a divalent aromatic radical
m is a number in the range from 3 to 1500.

16. The block copolymer according to claim 13, wherein the polymer blocks display a phase separation in the order of from 10 to 100 nm.

17. The block copolymer according to claim 15, wherein the polymer blocks display a phase separation in the order of from 10 to 100 nm.

18. A process for preparing aromatic polyether sulfone block copolymers according to claim 13, which comprises sulfonating an aromatic polyether sulfone block copolymer by means of concentrated sulfuric acid at a temperature in the range from 20 to 70° C.

19. A fuel cell comprising the aromatic polyether sulfone block copolymer according to claim 13 as polyelectrolyte.

20. A membrane for water treatment comprising the aromatic polyether sulfone block copolymer according to claim 13.
